(19) United States
(12) Patent Application Publication
(10) Pub. No.: US 2012/0037700 A1
(43) Pub. Date: Feb. 16, 2012

(54) ELECTRONIC DEVICE AND METHOD FOR IMAGE FILES WITH EMBEDDED INVENTORY DATA

(76) Inventors: Riaz WALJI, Markham (CA); Alex GERCHIKOV, Toronto (CA)

(21) Appl. No.: 13/208,791

(22) Filed: Aug. 12, 2011

Related U.S. Application Data
(60) Provisional application No. 61/373,028, filed on Aug. 12, 2010.

(51) Int. Cl. G06Q 30/00

(52) U.S. Cl. 235/385

(57) ABSTRACT

Systems, methods and devices are provided for documenting and tracking assets such as inventory items, contents, structural repairs, administrative line items and instructions and the like, in particular as it pertains to the contents restoration and insurance property claims industry. A mobile device such as a smartphone or digital camera is provided with onboard camera and wireless capabilities and is used to record identifying information and descriptive detail of inventory items on-site, including barcode or other indicia identifying the inventory items. This data is embedded in an image file representing a photograph of the inventory item for uploading to a database or other storage location for later processing.

### CROSS-REFERENCE TO RELATED APPLICATIONS

This application claims priority to U.S. Provisional Application No. 61/373,028 filed 12 Aug. 2010, the entirety of which is incorporated herein by reference.

### BACKGROUND

1. Technical Field

The present disclosure relates generally to identification and management of inventory items.

2. Description of the Related Art

In the field of contents restoration and in other industries where inventory cataloguing is an important function, convenient and accurate tracking of inventory items is desirable. In particular, contents restoration is typically undertaken in response to damage (due to fire, flood, smoke, other contamination, and the like) and requires removal of items from the affected property for assessment and restoration and/or storage, then subsequent return of items to their original locations on the property. Since any room in the property may contain a large number of items, and individual inventory items may be located in or connected to other items, the task of accurately cataloguing each item and its relationship to a given room or other inventory items in their vicinity may sometimes be a laborious and time-intensive process. An accurate catalogue of the items removed from the property is also desirable from an insurance claims and cost perspective. However, it may not be desirable for contents restoration personnel to remain on-site if conditions at the affected property present health hazards.

### BRIEF DESCRIPTION OF THE DRAWINGS

In drawings which illustrate by way of example only embodiments of the present disclosure,

FIG. 1 is a schematic diagram illustrating an example network topology for use with an electronic device and server for the present embodiments.

FIG. 2 is a schematic diagram illustrating components of a system providing a web service and executing on devices depicted in FIG. 1.

FIG. 3 is a schematic diagram illustrating components of a system providing a service and executing on devices depicted in FIG. 1.

FIGS. 4A, 4B and 4C are illustrations of user interface screens displayable on an electronic device as depicted in FIG. 1.

### DETAILED DESCRIPTION

The embodiments described herein provide a computing or communication device, system and method providing for enhanced and convenient cataloguing of inventory items for subsequent retrieval and reconciliation. These embodiments will be described and illustrated primarily in relation to portable digital camera and similar imaging devices, or other electronic devices equipped with camera or imaging technology. Such electronic devices may thus include digital cameras and imaging devices as well as computing and communication devices adapted to communicate over fixed or wireless networks, such as smartphones or tablet computers, similarly adapted to have either on-board camera or imaging technology, or alternatively connected to a camera or other imaging device (either by a fixed connection or by a wireless connection, such as Wi-Fi™, Bluetooth®, or a similar appropriate wireless protocol). It will be appreciated by those skilled in the art, however, that this description is not intended to limit the scope of the described embodiments to implementation on these particular devices. For example, the methods and systems described herein may be applied to any appropriate communication device or data processing device that is suitably adapted, whether portable or wirelessly enabled or not, whether provided with voice communication capabilities or not, and additionally or alternatively adapted to process data and carry out operations on data in response to user commands for any number of purposes, including productivity and entertainment. Thus, the embodiments described herein may be implemented on computing devices adapted for digital imaging or photography, including without limitation cellular phones, smartphones, wireless organizers, personal digital assistants, desktop computers, terminals, laptops, tablets, handheld wireless communication devices, notebook computers, entertainment devices such as MP3 or video players, and the like. Unless expressly stated, an electronic device, camera, or imaging device may include any such device.

The embodiments herein will be described and illustrated primarily in relation to inventory cataloguing in the field of contents restoration. However, it will be appreciated by those skilled in the art that these embodiments extend to other fields and industries, such as retail and warehouse inventory management. The description herein, to the extent that it refers to a specific field or industry application, is not intended to be so limiting unless expressly stated.

As indicated above, there is a need for convenient and accurate tracking of inventory items when cataloguing the items, either for the purpose of insurance claims, for contents restoration purposes, storage, and the like. Previous methods have typically involved significant operator interaction with the inventory items and/or files and notes made during the inventory process, either on-site when the inventory items are initially identified and collected, or off-site once data pertaining to the inventory items has been collected. For example, one method involves making a handwritten record of each inventory item, line by line, including any detailed information concerning observable damage, location on the property and within the room on the property. These handwritten notes can then be transcribed to a spreadsheet or database when the operator returns to the office. While the operator may, augment the record with photography to reduce the amount of handwritten notes, there remains the problem of associating the digital image of the inventory item with any notes regarding its condition and position. One means of addressing this is to photograph the item along with a paper or whiteboard, or a label that could be affixed to the item, bearing handwritten notes. However, to retrieve the notes at a later date (and optionally to transcribe the notes to an electronic text form), the photograph must be retrieved and reviewed. If it is not apparent from the photograph file name what the item is, then the operator may have to review numerous photographs before finding the right one.

Some of these problems may be alleviated by affixing or associating a barcode to the item. Using inventory software and barcode generating software executing on a portable computer, a barcode can be printed on a label and affixed to the inventory item; the item can be photographed using a digital camera, then the digital image transferred to the portable computer; the barcode can then be associated by the inventory software with the digital image, and the operator can then type in the detailed information for storage by the inventor software. However, even this process requires that the operator wait until the camera memory synchronizes with the portable computer, and that any images taken by the camera are transferred to the computer, before notes can be entered in the inventory software associated with the images. This process also requires numerous pieces of equipment to be brought on-site.

Regardless of the solution used, the amount of detailed information that must be taken for the catalogue requires time and skill on the part of the operator. For example, when cataloguing a computer monitor situated in a home or office, not only must the physical room where the monitor is located be noted, but also the physical relationship of the computer monitor to other furniture (e.g., the monitor is sitting on a desk) and to other movable items (e.g., the monitor has a removable power cord and video cable, and is connected to a computer). All of these solutions extend the amount of time the operator must spend on-site cataloguing inventory in potentially hazardous conditions.

Accordingly, the embodiments herein provide an improvement by using memo field technology with digital image files to allow the operator to use only a single portable device to capture the required information to catalogue inventory. The solution presented herein allows for recordal of images, barcode or other indicator information, accessory relationships (e.g. position of an item on, within, or connected to another item), original location, storage location, item category or type, and voice notes. The inventory management system used with this solution provides for post-collection tracking, e.g. the item status, chat or other conversation regarding the item, packaging information, warehouse status, and delivery.

Using a single electronic device, such as a digital camera, smartphone equipped for digital imaging, and the like, a digital image (or images) of the inventory item associated with a pre-printed barcode or other indicator is created, and the inventory item detailed information is embedded within a single file, resulting in a more portable file than the aforementioned solutions. The image and other data is captured in the single file on-site, then synchronized with a management system over the Internet (optionally over a wireless connection) or a direct data transfer. The management software retrieves the detailed information data embedded in the file and can then automatically create a line item for every inventory item, associating the item with the barcode detected in the image (if the barcode or other indicator is optically recognizable) as well as with any other data included in the file. Alternatively, the barcode or other indicator may be first scanned on-site using a scanning module of the electronic device and then automatically associated with the image, and the scanned indicator data included in the single file for transfer to the management system. When the line item is selected for viewing using the management software, the data retrieved from the file is accessible to the operator without requiring manual keying of detailed information.

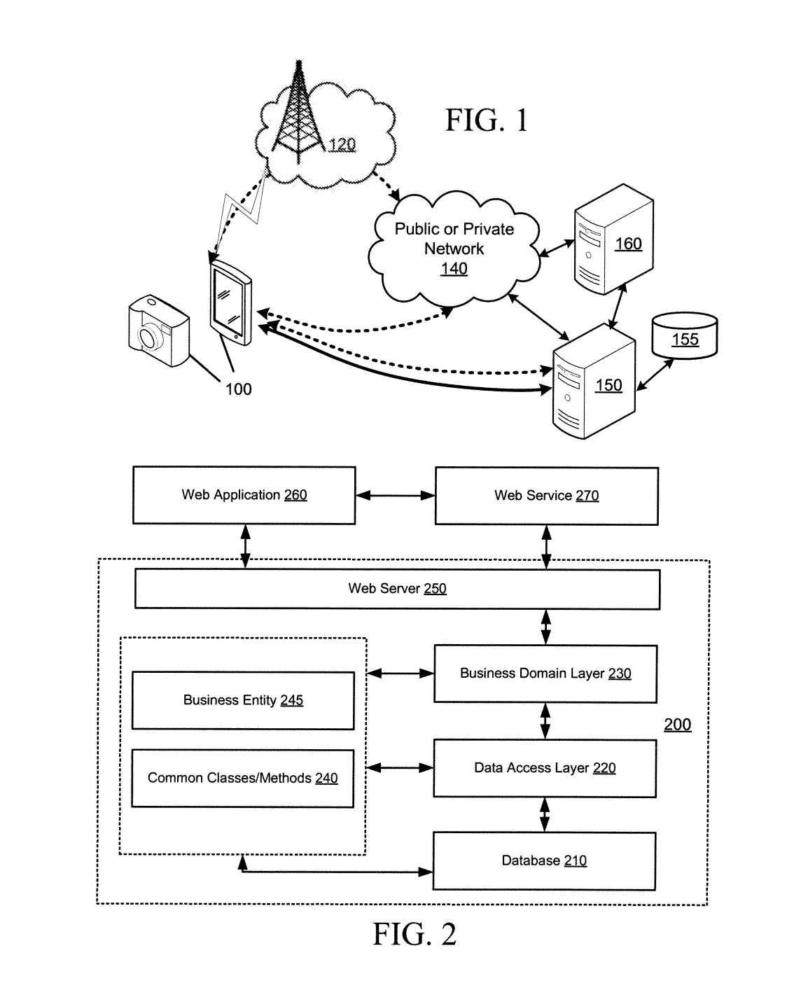

FIG. 1 illustrates a simple topography that may be employed with the electronic device 100, which may be, as illustrated in FIG. 1, a digital camera or a tablet or smartphone computing device (although as noted above the embodiments of the electronic device 100 need not be so restricted). The components of the electronic device 100, such as a communications subsystem for direct or wireless transfer of data over a network or a local connection to another device, imaging components, and one or more processors operative to execute imaging functions, operating system functions, and software applications will be known to those skilled in the art. The electronic device 100 can communicate with a server, personal computer or other electronic device 150 executing the management software, either via a direct connection (as illustrated by the solid line) or by at least a partially wireless connection (as illustrated by the phantom lines). As noted above, the electronic device 100 may be a digital camera, smartphone, or tablet computer. Further, in a preferred embodiment, the electronic device 100 is provided with at least one processor, a display, a digital imaging subsystem (e.g., a digital camera), local data store (volatile and/or non-volatile), at least one input subsystem such as a touchscreen, keyboard, buttons and the like, and a wireless communication subsystem for in accessing a wireless network or other public or private network.

For ease of reference, the electronic device 150 is referred to herein as a server, although this is not intended to be limiting. In one embodiment, the electronic device 100 may communicate with the server 150 in part over the Internet or another wide-area, public or private network 140. The electronic device 100 may access the public or private network 140 via a wireless hotspot or via a wireless network 120, although different means of communication with the server 150 may be implemented.

The service provided by the server 150 to the electronic device 100 may offered as a web service, in which case a separate web server 160 may be implemented. Communication between the electronic device 100 and the server 150 is therefore mediated by the web server 160, which provides an interface to the services executed by the server 150. The server 150 may have an integrated or separate data store 155 such as a database server, which operates to store data transferred from the electronic device 100.

A schematic diagram of the architecture of the services provided for the electronic device 100, where the services are accessible over the world wide web, is illustrated in FIG. 2. In this illustration, the system 200 includes the web server 250 as well as the services provided by the server 150 and the data store 155 of FIG. 1. The architecture of the services at the server 150 includes a database 210, which is accessed by a data access layer 220 of the management software, which in turn communicates with a business domain layer 230. The database 210, data access layer 220, and business domain layer 230 interact with business entity services 245 and various classes and methods 240 to provide the management services, via the web server 250, which offers access to the functions of the system 200 via a web service 270 and web application 260. The electronic device 100 interacts with the web application 260 to upload and retrieve data from the system 200. Although not illustrated, the server 150 may be protected from a public network 140 by a firewall.

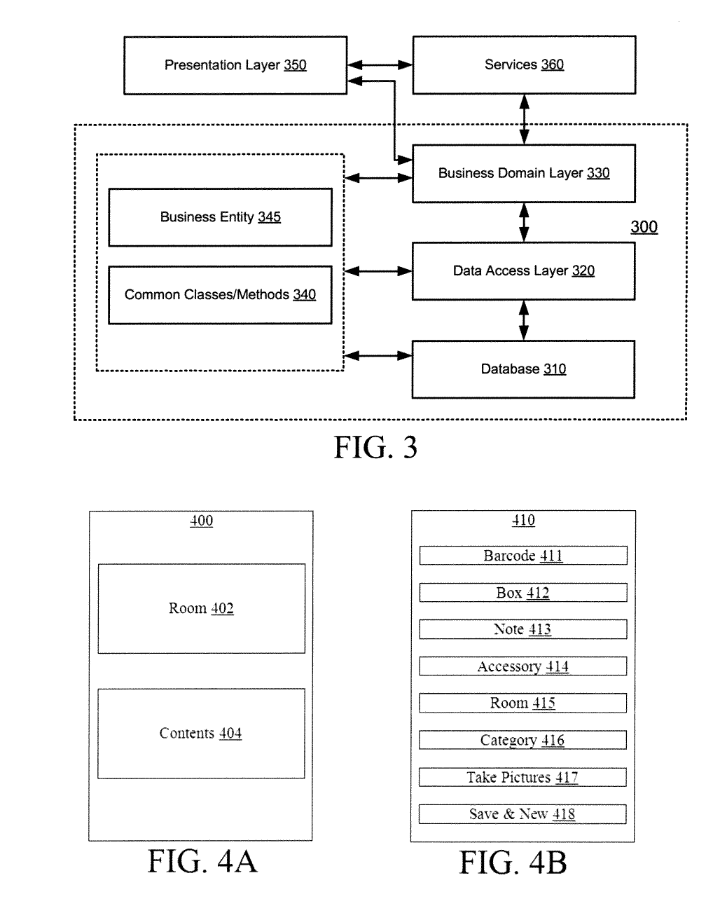

Alternatively, if the services are not provided via a web interface, the architecture may resemble that of FIG. 3, where the system includes a database 310, data access layer 320, business domain layer 330, business entity services 345, classes and methods 340, generally configured as in FIG. 2. The system 300 is accessible to the operator and/or electronic device 100 via the presentation layer 350, which provides access to other services 360.

In contents restoration process flow, when a new job or claim is created (i.e., identification of a property where inventory items are to be catalogued and picked up for restoration), typically a first step is the placement of an initial call to the customer having the claim, and to schedule a pick up. During pick up, the operator attends on-site and carries out the cataloguing process described below, and the catalogued items are then packed. This aspect of the process is generally referred to as “pack-out”. The items are taken off-site for restoration and/or cleaning, if feasible; some items may not be repairable. This part of the process thus typically includes inspection and possibly disposal of an item, if it is not repairable. Once the catalogued items have been restored and/or cleaned, the items are packaged for delivery to the property, and an appointment is made with the customer for delivery. The items can then be returned to their original locations on the property using the detailed information collected at the time of cataloguing. Using the management software, a pricing report can then be prepared for the customer.

For the pack-out process, the aforementioned electronic device is provided to the operator who attends on-site. To begin the pack-out process, the associated job is selected from a list of available jobs. The job contains a description of the current pack-out task (e.g. address, client name and contact information, and the like) and can be represented by an alphanumeric or other suitable identifier. All data entered at the electronic device is thus associated with the job identifier. If the job information is not already stored at the electronic device 100, then upon selection of a particular job identifier at the electronic device 100, the electronic device 100 requests the job information data from the server 150.

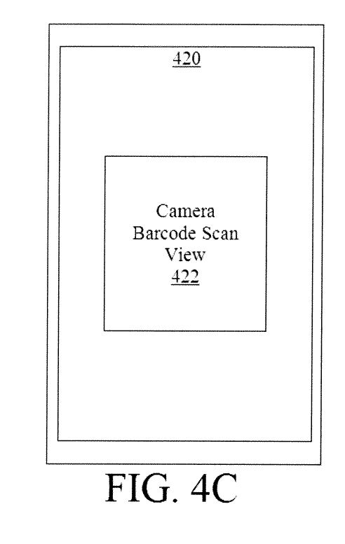

To commence inventory, a particular room is identified at the site (where there are multiple rooms at the site, each room will be assigned a different identifier). An example user interface screen permitting a user to select a particular room is illustrated in FIG. 4A, where options to choose a room 402 or entry of data relating to contents (i.e., an inventory item) 404 are provided on the screen 400. The room identifiers may be configured in advance at the server 150, and downloaded with the job information data. Typically, default room identifiers are assigned automatically at the server 150 when a job is initially configured. Alternatively, the room data may be input at the electronic device 100 if the device 100 is configured for keying in of data. While the room identifier may be a numeric identifier (e.g. 01, 02, 03 . . . ), the operator may add a more robust text description (e.g., “bedroom 1”). This robust description may replace the default numeric identifier at the electronic device 100, and may be uploaded to the server 150. The room identifier is selected for entry of inventory data.

The room itself may be catalogued for later reference. The operator may photograph, for example, one or more walls of the room, fixtures, closets, doors, windows, etc. and input measurements of these features or fixtures once the image is recorded. The various features and locations in the room may be marked with barcodes or similar indicators that have been pre-printed and brought to the site, and the barcodes scanned using a barcode scanning module when the image of that barcoded feature or location is taken. Thus, the scanned barcodes will be associated with the image of the feature or location, as well as with the room. An imaging program executing on the electronic device 100 may be configured to prompt the operator through the process of photographing or otherwise imaging the various room features; for example, the operator may be prompted to take photographs of each of the north, south, east, and west walls in turn; to select whether next photograph to be taken (or the most recent photograph taken) is of a wall, closet, fixture, or the like. Further, upon taking each photograph, the operator may be prompted to enter further data either by keying in text (e.g., a verbose description of the subject of the photograph), or by entering a voice memo that is recorded and digitized, and converted to an alphanumeric string. The length of the voice memo or any manual entry may be limited in size in view of limited storage capacity on the electronic device 100.

While the term “barcodes”, “barcoded”, and “barcoding” is used to generally denote an optically recognizable indicator affixed to or associated with various inventory items, rooms, locations and the like such as a UPC, EAN or ISBN code, or any other representation of alphanumeric data in an optically recognizable format and preferably compliant with a recognized standard such as EPN.UCC, it will be appreciated by those skilled in the art that the indicator need not be limited to such a typical two-dimensional barcode and need not be assigned in accordance with any predefined standard for allocating identification numbers. Rather, any scannable and electronic device-recognizable indicator may be used, including but not limited to barcodes, QR codes, RFID tags, and other optically recognizable or EM-readable indicia. The electronic device 100 may be equipped with a specialized hardware or software module configured to capture the indicator and to recognize data encoded therein. Such specialized components can include a barcode or QR code scanning application configured to use a digital camera provided in the device 100, or a dongle or other attachment adapted to transmit and receive EM or other signals (as in the case of an RFID reader). If the electronic device 100 is equipped for near-field communications (NFC), an on-board NFC reader may be used as well. Preferably, although not mandatory, in the case of RFID tags and the like, passive tags are used to minimize costs. The identification data encoded in the indicator need not be predefined in accordance with any standard, but may be generated or selected for use at a single site or on a single job, in which case the various indicators would only need to be sufficiently unique so as to uniquely distinguish each item inventoried at a particular site or job. Thus, while “barcodes” may be used herein for ease of reference to describe an embodiment, it will be understood that such language is interchangeable with “tags”, which is also used herein to generally describe such electronic device-readable indicia that encode information, such as a numeric or alphanumeric identifier, that can be read and decoded by the electronic device 100 and/or a module or component thereof or attached thereto. Further, in some embodiments, while previously prepared tags, such as pre-printed barcodes, may be brought on-site and used as described herein, those inventory items that were previously tagged—for example, in the case of a book, which would typically bear an ISBN code in barcode format—may simply be identified using that previous tag. In one embodiment, where tags are affixed to the inventory items, preferably waterproof, chemical resistant, and heatproof labels are used so that the inventory items can be easily tracked through the subsequent cleaning process.

Also, in preparation for cataloguing, boxes or other containers used to collect and transport movable items can be identified in association with the job and/or room. Identifiers for the boxes may be pre-assigned when the job information is initially created, or may be entered at the electronic device 100 on-site. The boxes or other containers themselves can be tagged and their tags scanned by the electronic device 100 to record their identifiers in association with the job and/or room.

Thus, once a room is selected and optionally catalogued as described above, each inventory item in the selected room can be catalogued. Returning to the screen 400 of FIG. 4A, the option to enter contents data 404 can be selected, and in response the electronic device 100 can display a data entry screen 410 shown in FIG. 4B. As illustrated in FIG. 4B, a number of data items can be input at the electronic device 100: barcode or tag data 411; box or container identifier data 412, notes 413, accessory identifiers 414, room 415 (this data item may be prepopulated if a room was preselected), category of content type 416 (e.g., electronics, soft goods, general contents, furniture, structural, and the like); and digital images or pictures 417. Each of these data items may be entered upon selecting the corresponding option displayed on the screen 410. Additionally, an option 418 to save the entered data for that item, and to create a new catalogue entry for a further item, is provided.

Thus, to enter the tag or barcode or to capture a digital image of the item, the operator can select the option 411 or 417, which can then invoke a camera and/or scanning module executable on the device, which displays further user interface screen 420 shown in FIG. 4C. The user can then use the camera of the electronic device 100 to capture either an image of the item (if a photograph is to be obtained), or of an optically recognizable tag, which would then be displayable in region 422. Once the image is captured by the electronic device 100, it is stored in local memory of the device 100. Upon capture of the image and/or tag data, the display can return to the screen 410. As part of the cataloguing process, the tag should be read for each item, so that the other input data items can be associated with the tag identifier. Selecting the box or container identifier option 412 permits the operator to select or define a box or container for storing the item; if the container does not exist as an entry on the device 100, then the operator may use a similar scanning method to record a tag for the container.

To enter notes, the option 413 is selected, which invokes a note input screen, not shown. In some embodiments this may be a text field into which the user can enter data by manual keying or by touch (if the electronic device 100 comprises a touchscreen interface). Alternatively, voice notes may be recorded and saved in association with the catalogued item, although in that case the length of the recordings may be short in order to maximize the number of catalogued items that can be stored at the electronic device 100. In one embodiment, a voice-to-text module is provided on the electronic device 100, so that spoken words captured by the device 100 are converted to text and stored in text form in association with the tag data. The operator may be given an opportunity to correct the text if the conversion to text is incorrect. In the notes field, the operator may enter comments about the condition of the inventory item, a description, quantity, measurements, make or model, and the like. In one embodiment, once a note is entered in the notes field, the operator may be presented with an option to save the note as a particular note type: general item note, pre-existing damage note, or task note. Upon upload, these different note types may be handled differently; for example, alerts concerning tasks or pre-existing damage may be delivered to different persons working on the contents restoration.

If the item is associated with any accessories, then upon selection of the accessories option 414, identifiers for any such accessory inventory items can be entered (e.g., if the item is a computer monitor, the computer and any pointing devices may be identified as accessories by scanning their tags using the above-described method). Optionally, the operator is provided with the option to define the inventory item being catalogued as a “parent” or “child” of the accessory. For example, if the inventory item is contained within the accessory item, the inventory item may be considered to be a “child” of the accessory item, whereas if the accessory item is a peripheral or ancillary feature of the inventory item (e.g., the accessory is a computer mouse and the inventory item is a computer), then the inventory item may be considered to be a “parent” of the accessory item. Once this data is recorded, the options screen 410 of FIG. 4B may reflect that an identifier for a “parent” or “child” accessory has been defined.

If the room for the inventory item has not already been preselected, the operator can select option 415 to select a room from a provided list of rooms, or the operator can enter new room data as described above.

In addition, the operator may be provided the option to mark a particular item as a “rush” item, thus flagging it for immediate attention. When the data items for that catalogued inventory item are uploaded, the management software can trigger a notification to an administrator that the inventory item requires special handling.

In some embodiments, where the electronic device 10 is configured to scan common commercial standard barcodes typically provided on products and their packaging, such as UPC, EAN and ISBN codes, the operator may omit to enter some of the additional data described above pertaining to the item description. For example, if the barcode scanned is an ISBN code, the operator may leave the notes field blank (unless there is a need to describe damage), and when the image file is uploaded to the server 150 as described below, the management system can operate to transmit a query to a service provider (which may be a subcontractor, web service or similar service provider) to obtain detailed information relating to that ISBN. In the case of an ISBN, which relates to a published book, the management system can retrieve the book title, author, and a physical description of the book (e.g. dimensions, number of pages) and the like.

However, for consistency, items with prior barcodes are also tagged separately, as described above. In that case the scanning of the ISBN would be a separate step, and the ISBN or other code will be included with the image data as described below, then retrieved later by the management system.

Once all desired data items are collected for the inventory item, the item data is saved. In saving, the various data components (tag or barcode data, room, accessory, category, and so forth) are embedded in the image file that was recorded for that item. The embedding may comprise insertion of the data, converted to ASCII characters, into fields comprised in the image file format. The image file may be, for example, configured to include Extensible Metadata Platform (XMP) metadata. XMP is a standard providing for the definition, creation and processing of metadata for embedding into files, following an XML structure. Other standards for embedding data in a graphics file are known, such as Exchangeable Image File Format (EXIF) and IPTC-IIM. These standards generally define data types such as creator, title, and copyright information to be embedded in file. However, in these embodiments, the standard data types are extended to include further data types reflecting the types of data items described above. Thus, in an example EXIF file format, the data items may be included as follows:

TABLE 1

| | |
|---|---|
| ExifTool Version Number | 8.16 |
| File Name | RIMG0002.JPG |
| . . . | |
| Barcode | K0003658 |
| Box | K0018088 |
| Voice | 594d7202ea760b22df50 . . . |
| Parent | K0390596 |
| Child | K0390596 |
| Room | 02 |
| Category | Electronics |
| Image Size | 1280 × 960 |
| Note general | |
| Note damage | dented corner upper left |
| Note task | |

Table 1 above illustrates possible data that may be stored in EXIF fields comprised in the image file. It will be appreciated by those skilled in the art that a number of possible fields are omitted in this illustration, particularly those pertaining to the file size, modification date/time, file permissions, file type, byte order, camera make and model, resolution, compression, photography information such as aperture size, exposure and the like, firmware version, flash mode, and a number of other possible fields for photograph metadata that will be known to those skilled in the art. Where no data is entered (for example, in the above table, no general notes were entered), the field is left blank. The actual compression file format of the image may be JPG (as in the above table), or another suitable taggable format such as TIFF. If a particular inventory item is then reviewed on the electronic device 100, the image file is retrieved, and the EXIF fields read out to populate a display screen such as FIG. 4B.

Other functions may be provided on the electronic device 100, such as a calendar function for tracking and displaying scheduled tasks, time tracking, and the like.

With the foregoing electronic device 100 and process, the operator can capture important details of inventory items while minimizing loss due to human error (such as incomplete handwritten notes, transcription errors, and the like) and decreasing the time in which individual items are catalogued. Further, the use of tags in the manner described above provides for easy identification of parent-child accessory arrangements. In addition, because the inventory item data is embedded in the image file itself, there is no need to wait for the image file to be uploaded to a server or a personal computer or other computing device before being able to enter further item details, since the item details are already included in the file.

Once the inventory items have been catalogued, the individual image files can be uploaded to the server 150 file-by-file, or in batches. For example, upon saving each image file with embedded data, the electronic device 100 may be configured to upload the image file to the server. Upon successful upload, the file may be deleted from local storage on the electronic device 100, either immediately after upload or on a periodic basis, to release additional storage space for further images. If no connection to the server 150 is available at the time, the image file is retained at the electronic device 100 until a connection is successfully made. The image file may be flagged for upload or otherwise tracked in an upload queue pending connection. If, during upload, the connection fails, the image file is retained on the device 100 and the transfer continues when reconnection is accomplished. In some embodiments, if there is sufficient storage space on the device 100, the image files are uploaded only once the job is marked as complete on the device 100.

Preferably, uploading is automated on the electronic device 100 without user intervention. However, the operator may select individual image files on the electronic device 100 for manual upload, or select folders of image files for upload.

At the server 150, once the images are uploaded, the EXIF metadata is extracted from each file and used to populate a database with the inventory item data that had been embedded in the file, as well as the image data itself. The data may be reviewed by an operator at a location remote from the site to monitor the status of inventory items as they pass through the restoration process, including cleaning, replacement pricing, and the like. Further, the management system implemented at the server 150 may be accessible by remote users, for example over the Internet, to track the status of a particular job or insurance claim. Different levels of access to the data at the server 150 may be assigned by an administrator of the management system to different interested parties, such as the insured, the claims adjuster, subcontractors tasked with cleaning, pricing, and so forth, and the like.

The embodiments herein thus provide means for an operator to capture images and information on locations, rooms, inventory items and related items using a single electronic device 100 that is brought on-site, without requiring additional equipment to record ancillary information that could not be captured in a prior art image file.

There is thus provided an electronic device, comprising: a digital imaging subsystem; a data store; a wireless communication subsystem; at least one input subsystem; and at least one processor in communication with the digital imaging subsystem, the data store, the wireless communication subsystem, and the at least one input subsystem, the at least one processor being configured to: receive input data via the at least one input subsystem defining an inventory item; receive via the digital imaging subsystem image data for a captured image of the inventory item; receive via the digital imaging subsystem tag data comprising indicator information associated with the inventory item; embed the input data and the tag data in an image file comprising the image data and store said image file comprising said embedded input data and tag data in the data store; and upload said image file comprising said embedded input data and tag data to a receiving device via the wireless communication subsystem.

In one aspect, the at least one processor is further configured to: receive further input data via the at least one input subsystem defining the further inventory item; receive via the digital imaging subsystem further image data for a captured image of the further inventory item; receive via the digital imaging subsystem further tag data comprising indicator information associated with the further inventory item; and embed the further input data and the further tag data for said further inventory item in a further image file comprising the further image data and store said further image file in the data store.

There is also provided a method implemented at an electronic device, the method comprising: receiving input data via at least one input subsystem defining an inventory item; receiving via a digital imaging subsystem image data for a captured image of the inventory item; receiving via the digital imaging subsystem tag data comprising indicator information associated with the inventory item; embedding the input data and the tag data in an image file comprising the image data and store said image file comprising said embedded input data and tag data in a data store; and uploading said image file comprising said embedded input data and tag data to a receiving device via a wireless communication subsystem.

In one aspect, the method further comprises: receiving further input data via the at least one input subsystem defining the further inventory item; receiving via the digital imaging subsystem further image data for a captured image of the further inventory item; receiving via the digital imaging subsystem further tag data comprising indicator information associated with the further inventory item; and embedding the further input data and the further tag data for said further inventory item in a further image file comprising the further image data and storing said further image file in the data store.

In one aspect of the above device and method, the electronic device is a digital camera. In a further aspect, the electronic device is a smartphone. Further, the electronic device may be a tablet.

In another aspect of the above device and method, the embedded input data and tag data is stored in EXIF format.

In still another aspect, the electronic device is configured to communicate with the receiving device at least in part over a wireless network, and the receiving device comprises a server. The server or other receiving device may be provided with a management system and software configured to receive the image files with embedded data, to extract the embedded data, and to populate a database with the extracted data and optionally the image data comprised in the image files for later retrieval.

In yet a further aspect, the input data comprises voice memo data, the voice memo data being embedded in the image file.

In another aspect of the foregoing embodiments, the input data comprises accessory relationship data, the accessory relationship data indicating a parent-child relationship with a further inventory item.

There is also provided an electronic device-readable medium, which may be physical or non-transitory and which may be embodied in an electronic device program product such as a memory device, the medium storing code, which when executed by an electronic device, causes said electronic device to carry out the above described method.

The systems and methods disclosed herein are presented only by way of example and are not meant to limit the scope of the subject matter described herein. Other variations of the systems and methods described above will be apparent to those in the art and as such are considered to be within the scope of the subject matter described herein. For example, it should be understood that steps and the order of the steps in the processing described herein may be altered, modified and/or augmented and still achieve the desired outcome. Throughout the specification, terms such as “may” and “can” are used interchangeably and use of any particular term should not be construed as limiting the scope or requiring experimentation to implement the claimed subject matter or embodiments described herein.

The systems' and methods' data may be stored in one or more data stores. The data stores can be of many different types of storage devices and programming constructs, such as RAM, ROM, flash memory, programming data structures, programming variables, etc. It is noted that data structures describe formats for use in organizing and storing data in databases, programs, memory, or other computer-readable media for use by a computer program.

Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. Various functional units described herein have been expressly or implicitly described as modules and agents, in order to more particularly emphasize their independent implementation and operation. It is also noted that an agent, module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The various functional units may be implemented in hardware circuits comprising custom VLSI circuits or gate arrays; field-programmable gate arrays; programmable array logic; programmable logic devices; commercially available logic chips, transistors, and other such components. Modules implemented as software for execution by a processor or processors may comprise one or more physical or logical blocks of code that may be organized as one or more of objects, procedures, or functions. The modules need not be physically located together, but may comprise code stored in different locations, such as over several memory devices, capable of being logically joined for execution. Modules may also be implemented as combinations of software and hardware, such as a processor operating on a set of operational data or instructions.

A portion of the disclosure of this patent document contains material which is or may be subject to one or more of copyright, design patent, industrial design, or unregistered design protection. The rightsholder has no objection to the reproduction of any such material as portrayed herein through facsimile reproduction of the patent document or patent disclosure, as it appears in the Patent and Trademark Office patent file or records, but otherwise reserves all rights whatsoever.

1. An electronic device, comprising:
a digital imaging subsystem;
a data store;
a wireless communication subsystem;
at least one input subsystem; and
at least one processor in communication with the digital imaging subsystem, the data store, the wireless communication subsystem, and the at least one input subsystem, the at least one processor being configured to:
receive input data via the at least one input subsystem defining an inventory item;
receive via the digital imaging subsystem image data for a captured image of the inventory item;
receive via the digital imaging subsystem tag data comprising indicator information associated with the inventory item;
embed the input data and the tag data in an image file comprising the image data and store said image file comprising said embedded input data and tag data in the data store; and
upload said image file comprising said embedded input data and tag data to a receiving device via the wireless communication subsystem.

2. The electronic device of claim 1, wherein the electronic device is a digital camera.

3. The electronic device of claim 1, wherein the electronic device is a smartphone.

4. The electronic device of claim 1, wherein the embedded input data and tag data is stored in EXIF format.

5. The electronic device of claim 1, wherein the electronic device is configured to communicate with the receiving device at least in part over a wireless network, and the receiving device comprises a server.

6. The electronic device of claim 1, wherein the input data comprises voice memo data, the voice memo data being embedded in the image file.

7. The electronic device of claim 1, wherein the input data comprises accessory relationship data, the accessory relationship data indicating a parent-child relationship with a further inventory item.

8. The electronic device of claim 7, wherein the at least one processor is further configured to:
receive further input data via the at least one input subsystem defining the further inventory item;
receive via the digital imaging subsystem further image data for a captured image of the further inventory item;
receive via the digital imaging subsystem further tag data comprising indicator information associated with the further inventory item; and
embed the further input data and the further tag data for said further inventory item in a further image file comprising the further image data and store said further image file in the data store.

9. A method implemented at an electronic device, the method comprising:
receiving input data via at least one input subsystem defining an inventory item;
receiving via a digital imaging subsystem image data for a captured image of the inventory item;
receiving via the digital imaging subsystem tag data comprising indicator information associated with the inventory item;
embedding the input data and the tag data in an image file comprising the image data and store said image file comprising said embedded input data and tag data in a data store; and
uploading said image file comprising said embedded input data and tag data to a receiving device via a wireless communication subsystem.

10. The method of claim 9, wherein the electronic device is a digital camera.

11. The method of claim 9, wherein the electronic device is a smartphone.

12. The method of claim 9, wherein the embedded input data and tag data is stored in EXIF format.

13. The method of claim 9, further comprising uploading said image file at least in part over a wireless network, and the receiving device comprises a server.

14. The method of claim 9, wherein the input data comprises voice memo data, the voice memo data being embedded in the image file.

15. The method of claim 9, wherein the input data comprises accessory relationship data, the accessory relationship data indicating a parent-child relationship with a further inventory item.

16. The method of claim 15, further comprising:
receiving further input data via the at least one input subsystem defining the further inventory item;
receiving via the digital imaging subsystem further image data for a captured image of the further inventory item;
receiving via the digital imaging subsystem further tag data comprising indicator information associated with the further inventory item; and
embedding the further input data and the further tag data for said further inventory item in a further image file comprising the further image data and storing said further image file in the data store.

17. A non-transitory electronic device-readable medium storing code, which when executed by an electronic device, causes said electronic device to:
receive input data via an at least one input subsystem defining an inventory item;
receive via a digital imaging subsystem image data for a captured image of the inventory item;
receive via the digital imaging subsystem tag data comprising indicator information associated with the inventory item;
embed the input data and the tag data in an image file comprising the image data and store said image file comprising said embedded input data and tag data in a data store; and
upload said image file comprising said embedded input data and tag data to a receiving device via a wireless communication subsystem.
